(19) United States
(12) Patent Application Publication
(10) Pub. No.: US 2019/0390523 A1
(43) Pub. Date: Dec. 26, 2019

(54) Methods Of Reconstituting Cores, Formation Cores With Actual Formation Materials For Lab Testing

(71) Applicant: Halliburton Energy Services, Inc., Houston, TX (US)

(72) Inventors: Philip D. NGUYEN, Houston, TX (US); Vladimir Nikolayevich MARTYSEViCH, Spring, TX (US); Tatyana V. KHAMATN U RGVA, Spring, TX (US); Christopher R. PARTGN, Humble, TX (US)

(21) Appl. No.: 16/481,787

(22) PCT Filed: Mar. 30, 2017
(86) PCT No.: PCT/US2017/025092

§ 371 Date: Jul. 29, 2019

(51) Int. Cl. E21B 21/06; E21B 49/02

(52) U.S. Cl. CPC E21B 21/066; F26B 5/08; E21B 49/02

(57) ABSTRACT

A method to produce reconstituted structures that recreate the chemical, geological, and structural characteristics of a portion of a target reservoir formation by using drill cuttings material from the target reservoir formation. The method includes providing drill cuttings material from a known reservoir formation and grinding the drill cuttings material to particulates of one or more known particle sizes. In particular, an actual core sample may be replicated via a three-dimensional printer using the ground drill cuttings material from the target reservoir formation. A representative reconstituted structure may also be formed by applying a load to the ground drill cuttings material from the target reservoir formation. A slot flow device may also be formed via either three-dimensional printing with drill cutting particulates or the application of a load to the drill cutting particulates.

### TECHNICAL FIELD

The present disclosure relates to producing reconstituted structures that recreate the chemical, geological, and structural characteristics of a portion of a wellbore by using drill cuttings material from the target wellbore. In particular, an actual core sample may be replicated via a three-dimensional printer or representative reconstituted structures may be formed using drill cuttings material from a target wellbore.

### BACKGROUND

The present disclosure relates generally to operations performed in conjunction with subterranean wells and, in an embodiment described herein, more particularly provides methods for producing reconstituted structures that recreate the characteristics of an actual core sample by using drill cuttings material from the borehole. The reconstituted structures may then be used for lab testing and evaluation purposes similar to testing traditionally performed on actual sample cores.

Wellbores are often drilled through a geologic formation for hydrocarbon exploration and recovery operations. Drilling and production operations involve a great quantity of information and measurements relating to parameters and conditions downhole. Such information typically includes characteristics of the earth formations traversed by the wellbore in addition to data relating to the size and configuration of the borehole itself.

Core samples are often extracted from a target area by drilling into the Earth. Core samples are extremely valuable; however, the cost and time associated with extracting such core samples is often prohibitive. Some geological tests performed on core samples are destructive, and essentially consume the core sample by the end of the test. Some of these tests can evaluate how the core sample reacts to fluids to be pumped into a well.

Hydrocarbon-producing wells may be stimulated by hydraulic fracturing operations. In hydraulic fracturing operations, a liquid slurry or viscous fracturing fluid, which also functions as a carrier fluid, is pumped into a producing zone at a rate and pressure to break down or erode the subterranean formation and form at least one fracture is in the zone. Particulate solids, such as sand, suspended in a portion of the fracturing fluid are then deposited in the fractures. These particulate solids or proppant particulates help prevent the fractures from fully closing and allow conductive channels to form through which produced hydrocarbons can flow. The proppant particulates used to prevent fractures from fully closing may be naturally-occurring, man-made or specially engineered, such as sand grains, bauxite, ceramic spheres, or aluminum oxide pellets, which are deposited into fractures as part of a hydraulic fracturing treatment. Using the core sample test results to understand how the core samples react to fluids to be pumped into a well can help determine more suitable fracturing fluids, chemical additives such as surfactants, clay stabilizers, etc., or proppant particulates to use in a particular reservoir formation.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements. Embodiments are described in detail hereinafter with reference to the accompanying figures, in which:

FIG. 1 is an elevation view in partial cross section of a land-based well system with according to an embodiment;

FIG. 2 is an elevation view in partial cross section of a marine-based well system according to an embodiment;

FIG. 3 illustrates embodiments of a method for reconstituting formation structures according to an embodiment;

FIG. 4 is a schematic diagram of grinding drill cuttings material;

FIGS. 5A through 5C are schematic, isometric views of various chambers of FIG. 4;

FIG. 6A is a schematic diagram of the chamber of FIG. 4;

FIG. 6B is a schematic diagram of consolidated structures having various geometries;

FIG. 7 illustrates embodiments of a method for reconstituting formation structures with a three-dimensional printer according to an embodiment;

FIG. 8 is a schematic diagram of grinding drill cuttings material;

FIG. 9 illustrates embodiments of a method for forming a slot flow apparatus according to an embodiment;

FIG. 10 is a schematic diagram of grinding drill cuttings material; and

FIG. 11 is a schematic diagram of a slot flow device with an insert according to an embodiment.

### DETAILED DESCRIPTION OF THE DISCLOSURE

The disclosure may repeat reference numerals and/or letters in the various examples or figures. This repetition is for the purpose of simplicity and clarity and does not in itself dictate a relationship between the various embodiments and/or configurations discussed. Further, spatially relative terms, such as beneath, below, lower, above, upper, uphole, downhole, upstream, downstream, and the like, may be used herein for ease of description to describe one element or feature's relationship to another element(s) or feature(s) as illustrated, the upward direction being toward the top of the corresponding figure and the downward direction being toward the bottom of the corresponding figure, the uphole direction being toward the surface of the wellbore, the downhole direction being toward the toe of the wellbore. Unless otherwise stated, the spatially relative terms are intended to encompass different orientations of the apparatus in use or operation in addition to the orientation depicted in the figures. For example, if an apparatus in the figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

Moreover, even though a figure may depict a horizontal wellbore or a vertical wellbore, unless indicated otherwise, it should be understood by those skilled in the art that the apparatus according to the present disclosure is equally well-suited for use in wellbores having other orientations including vertical wellbores, slanted wellbores, multilateral wellbores, or the like. Likewise, unless otherwise noted, even though a figure may depict an offshore operation, it should be understood by those skilled in the art that the apparatus according to the present disclosure is equally well-suited for use in onshore operations and vice-versa.

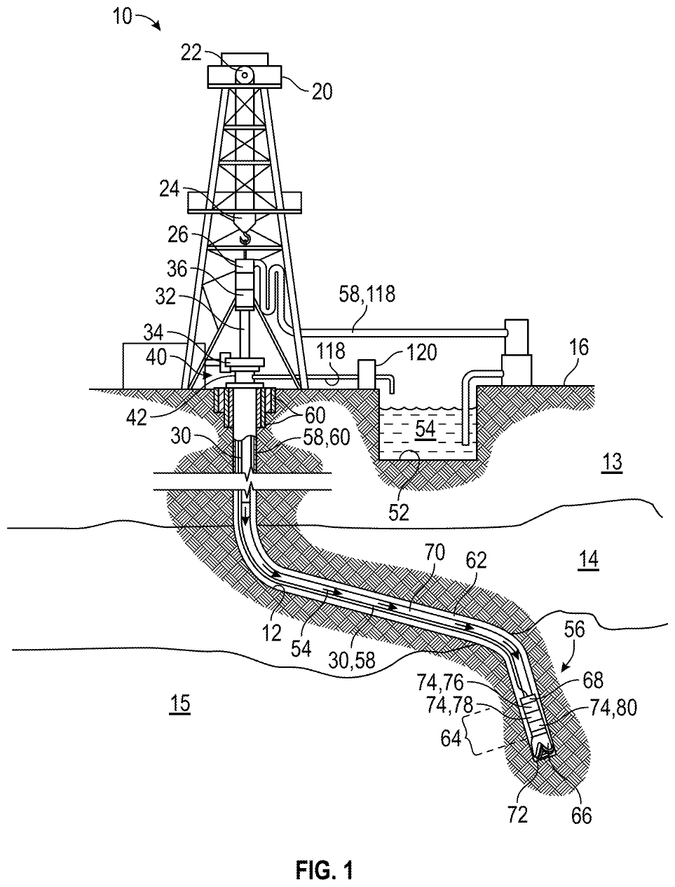

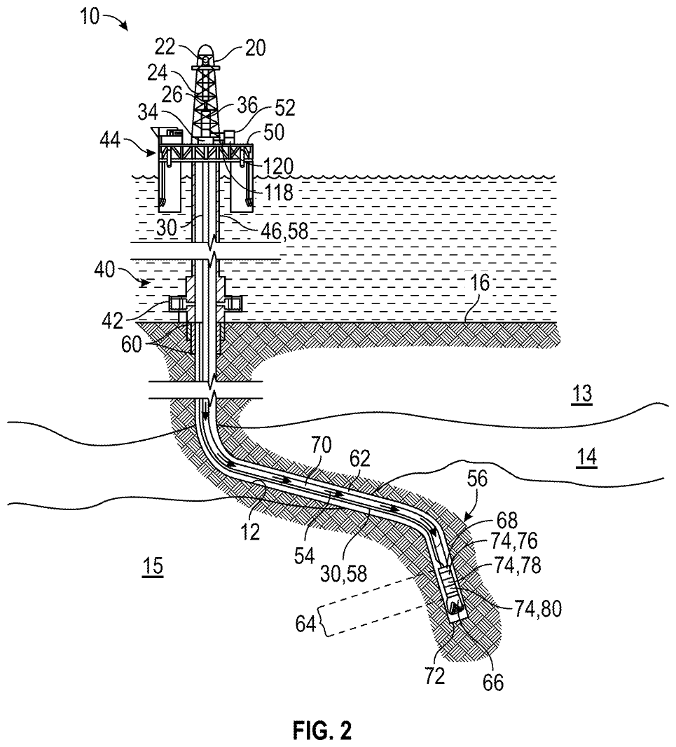

Turning to FIGS. 1 and 2, shown is an elevation view in partial cross-section of a wellbore drilling and production system 10 utilized to produce hydrocarbons from wellbore 12 extending through various earth strata 13, 14 in an oil and gas reservoir or formation 15 located below the earth's surface 16. Wellbore 12 may be formed of a single or multiple bores extending into the reservoir formation 15, and disposed in any orientation. The reservoir formation 15 may comprise sandstones, carbonates, coals, shales, or a combination thereof, among other materials.

Drilling and production system 10 includes a drilling rig or derrick 20. Drilling rig 20 may include a hoisting apparatus 22, a travel block 24, and a swivel 26 for raising and lowering casing, drill pipe, coiled tubing, production tubing, other types of pipe or tubing strings or other types of conveyance vehicles such as wireline, slickline, and the like 30. In FIG. 1, conveyance vehicle 30 is a substantially tubular, axially extending drill string formed of a plurality of drill pipe joints coupled together end-to-end, while in FIG. 2, conveyance vehicle 30 is completion tubing supporting a completion assembly as described below. Drilling rig 20 may include a kelly 32, a rotary table 34, and other equipment associated with rotation and/or translation of tubing string 30 within a wellbore 12. For some applications, drilling rig 20 may also include a top drive unit 36.

Drilling rig 20 may be located proximate to a wellhead 40 as shown in FIG. 1, or spaced apart from wellhead 40, such as in the case of an offshore arrangement as shown in FIG. 2. One or more pressure control devices 42, such as blowout preventers (BOPs) and other equipment associated with drilling or producing a wellbore may also be provided at wellhead 40 or elsewhere in the system 10.

For offshore operations, as shown in FIG. 2, whether drilling or production, drilling rig 20 may be mounted on an oil or gas platform 44, such as the offshore platform as illustrated, semi-submersibles, drill ships, and the like (not shown). Although system 10 of FIG. 2 is illustrated as being a marine-based production system, system 10 of FIG. 2 may be deployed on land. Likewise, although system 10 of FIG. 1 is illustrated as being a land-based drilling system, system 10 of FIG. 1 may be deployed offshore. In any event, for marine-based systems, one or more subsea conduits or risers 46 extend from deck 50 of platform 44 to a subsea wellhead 40. Tubing string 30 extends down from drilling rig 20, through subsea conduit 46 and BOP 42 into wellbore 12.

A working or service fluid source 52, such as a storage tank or vessel, may supply a working fluid 54 pumped to the upper end of tubing string 30 and flow through tubing string 30. Working fluid source 52 may supply any fluid utilized in wellbore operations, including without limitation, drilling fluid, cementious slurry, acidizing fluid, liquid water, steam or some other type of fluid.

Wellbore drilling and production system 10 may generally be characterized as having a pipe system 58. For purposes of this disclosure, pipe system 58 may include casing, risers, tubing, drill strings, completion or production strings, subs, heads or any other pipes, tubes or equipment that couples or attaches to the foregoing, such as string 30, conduit 46, collars 63, joints, and latch couplings as well as the wellbore 12 and laterals in which the pipes, casing and strings may be deployed. In this regard, pipe system 58 may include one or more casing strings 60 that may be cemented in wellbore 12, such as the surface, intermediate and production casings 60 shown in FIG. 1. An annulus 62 is formed between the walls of sets of adjacent tubular components, such as concentric casing strings 60 or the exterior of tubing string 30 and the inside wall of wellbore 12 or casing string 60, as the case may be.

Wellbore 12 may include subsurface equipment 56 disposed therein, such as, for example, a drill bit and bottom hole assembly (BHA) 64, a completion assembly or some other type of wellbore tool. Thus, where subsurface equipment 56 is used for drilling and conveyance vehicle 30 is a drill string, the lower end of drill string 30 may include BHA 64, which may carry at a distal end a drill bit 66. During drilling operations, weight-on-bit (WOB) is applied as drill bit 66 is rotated, thereby enabling drill bit 66 to engage reservoir formation 15 and drill wellbore 12 along a predetermined path toward a target zone in the reservoir formation 15. In general, drill bit 66 may be rotated with drill string 30 from rig 20 with top drive 36 or rotary table 34, and/or with a downhole mud motor 68 within BHA 64. The working fluid 54 pumped to the upper end of drill string 30 flows through the longitudinal interior 70 of drill string 30, through BHA 64, and exit from nozzles formed in drill bit 66. At bottom end 72 of wellbore 12, drilling fluid 54 may mix with formation cuttings 11, formation fluids and other downhole fluids and debris. The drilling fluid mixture may then flow upwardly through an annulus 62 to return formation cuttings 11 and other downhole debris to the surface 16.

Bottom hole assembly 64 and/or drill string 30 may include various other tools 74, including a power source 76, mechanical subs 78 such as directional drilling subs, and a core drill 80. Measurement while drilling (MWD) and/or logging while drilling (LWD) instruments, detectors, circuits, or other equipment may also be included in BHA 64 to provide information about wellbore 12 and/or reservoir formation 15, such as logging or measurement data from wellbore 12. Measurement data and other information from tools 74 may be communicated using electrical signals, acoustic signals or other telemetry that can be converted to electrical signals at the rig 20 to, among other things, monitor the performance of drilling string 30, BHA 64, and associated drill bit 66, as well as monitor the conditions of the environment to which the BHA 64 is subjected.

Fluids, cuttings 11 and other debris returning to surface 16 from wellbore 12 are directed by a flow line 118 to storage tanks 54 and/or processing systems 120, such as shakers, centrifuges and the like. The cuttings 11 may be transported to a location away from the wellbore 12, such as a laboratory or other facility where the cuttings 11 may be used in the reconstitution of formation structures. Cuttings 11 may comprise remnants of drilled formation cores 80a as drilled by core drill 80, and thus may also generally be referred to as formation core cuttings, formation cuttings, or drill cuttings material 11.

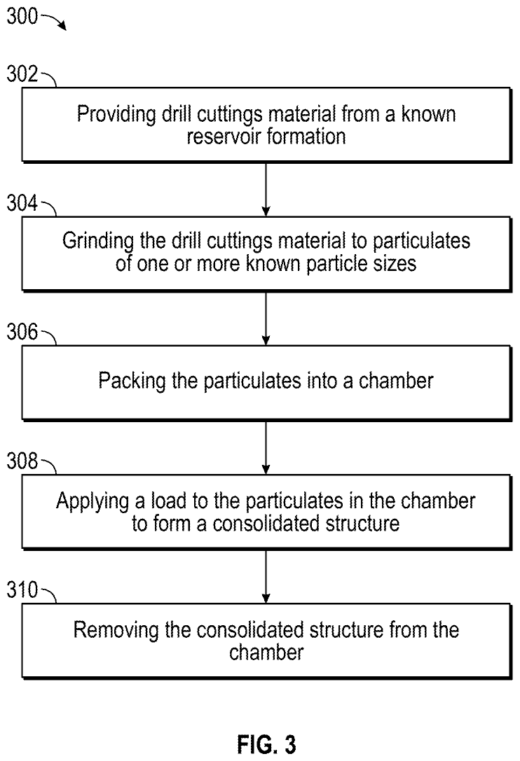

Referring now to FIG. 3, a method 300 of reconstituting formation structures is shown. In a first step 302, drill cuttings 11 from a known reservoir formation 15 are provided (FIGS. 1 and 2). In step 304, the drill cuttings material 11 is ground to particulates 402 of one or more known particle sizes.

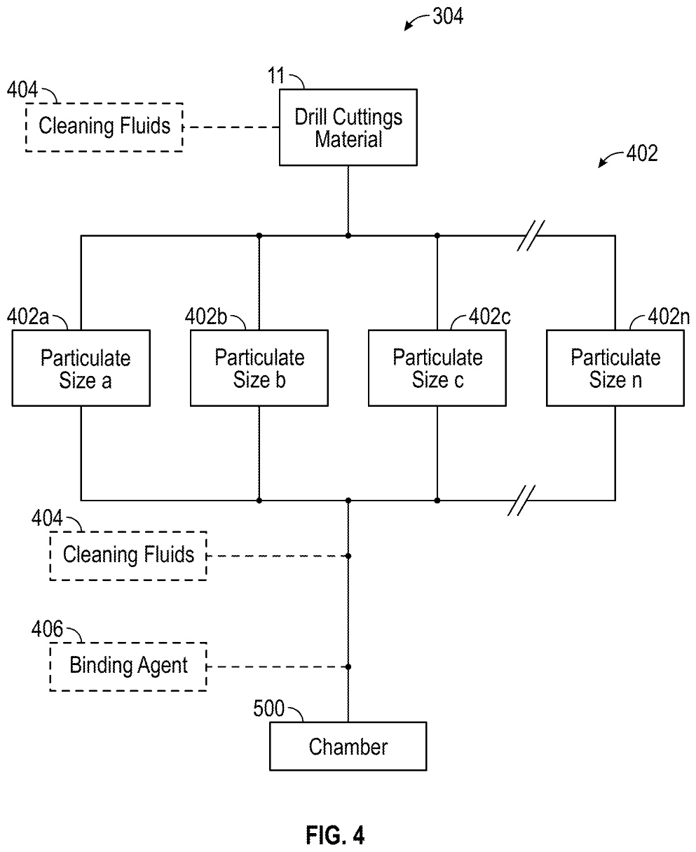

Referring also to FIG. 4, step 304 is shown in further detail. Drill cuttings material 11 may be ground to a first size a forming first particulate 402a, and a portion of first particulate 402a may be further ground to a second size b forming second particulate 402b. A portion of second particulate 402b may be further ground to a third size c forming third particulate 402c, and the process may continue any number of additional times to an nth size n forming nth particulate 402n. One or more cleaning fluids 404 may optionally be applied to the drill cuttings material 11 before or after being ground to particulates 402. Any suitable cleaning fluids 404 known in the art may be used including, but not limited to, a solvent based fluid, including dipropylene glycol methyl ether, dipropylene glycol dimethyl ether, dimethyl formamide, diethyleneglycol methyl ether, ethyleneglycol butyl ether, diethyleneglycol butyl ether, propylene carbonate, butyl alcohol, d′limonene, fatty acid methyl esters, methanol, isopropanol, butanol, glycol ether solvents, diethylene glycol methyl ether, dipropylene glycol methyl ether, 2-butoxy ethanol, ethers of a C2 to C6 dihydric alkanol containing at least one C1 to C6 alkyl group, mono ethers of dihydric alkanols, methoxypropanol, butoxyethanol, hexoxyethanol, and isomers thereof, and any derivative thereof, and any combination thereof; an aqueous-based fluid comprising water and a surfactant, wherein the surfactant is an ionic surfactant, nonionic surfactant, or a combination of ionic and nonionic surfactants. The ionic surfactant is selected from the group including, but not limited to, sodium oleate, sodium stearate, sodium dodecylbenzenesulfonate, sodium myristate, sodium laurate, sodium decanoate, sodium caprylate, sodium cetyl sulfate, sodium myristyl sulfate, sodium lauryl sulfate, sodium decyl sulfate, sodium octyl sulfate, derivatives of any of the foregoing, and combinations thereof. The nonionic surfactant is selected from the group including, but not limited to, ethoxylated aliphatic alcohols, nonylphenol ethoxylates, octylphenol ethoxylates, sulfoxide esters, polyoxyethylene, carboxylic esters, polyethylene glycol esters, anhydrosorbitol ester and ethoxylated derivatives, glycol esters of fatty acids, carboxylic amides, monoalkanolamine condensates, polyoxyethylene fatty acid amides, branched alkylphenol alkoxylates, linear alkylphenol alkoxylates, branched alkyl alkoxylates, derivatives of any of the foregoing, and combinations thereof. A binding agent 406 may also be optionally added to the particulates 402 to coat the particulates 402. Any suitable binding agent 406 known in the art may be used including, but not limited to, a curable resin, a cement, an inorganic geopolymer, or any combination of a curable resin, a cement, and an inorganic geopolymer.

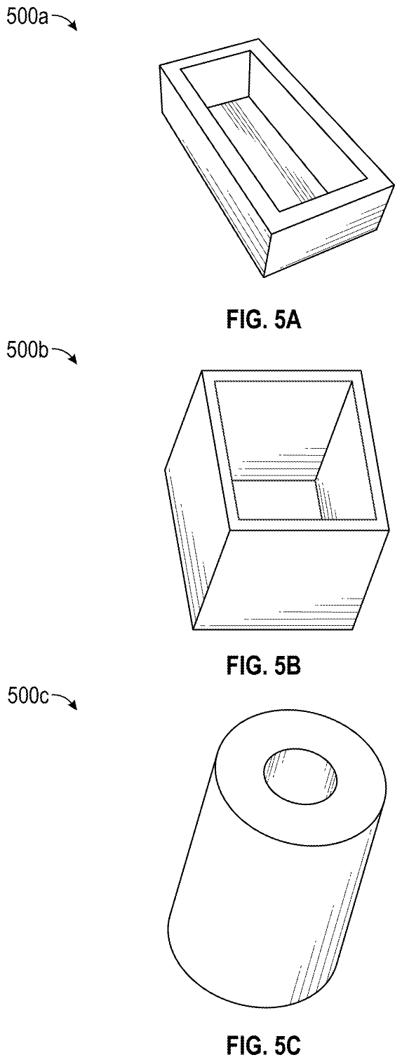

In step 306, particulates 402 are packed into a chamber 500. The size of the particulates 402a, 402b, 402c, . . . 4n, including the variety of sizes a, b, c, . . . n, may be selected based on the characteristics and geometry of the target reservoir formation 15. Chamber 500 may be of varying geometries. Referring now to FIGS. 5A-5C illustrating various chamber configurations 500, for example, chamber 500 may be generally block-shaped 500a (shown in FIG. 5A), generally cube-shaped 500b (shown in FIG. 5B), or generally cylinder-shaped 500c (shown in FIG. 5C).

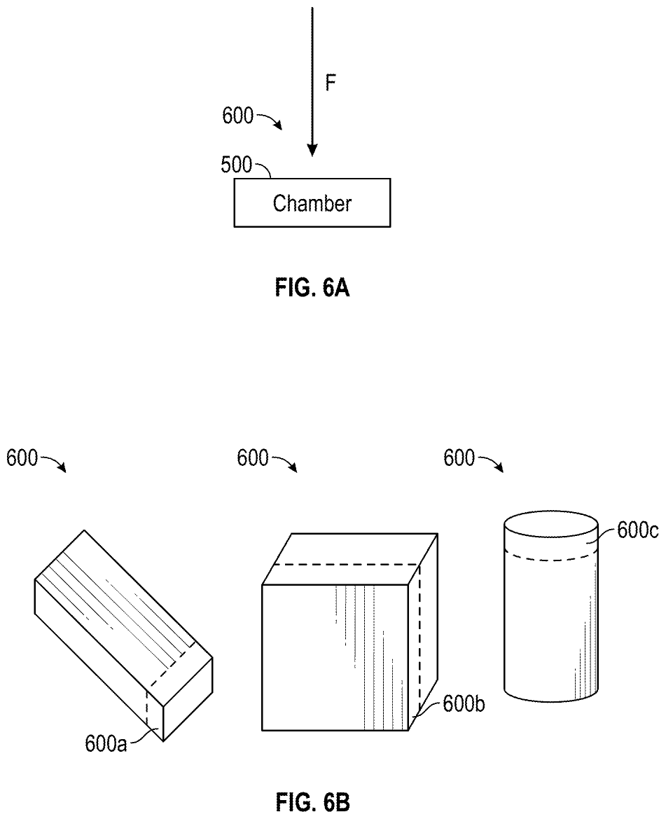

In step 308, a load F is applied to the particulates 402 in the chamber 500 to form a consolidated structure 600 (shown in FIG. 6). Load F may gradually increase and be maintained as a high stress load for a period of time. In an embodiment, load F may range from 1,000 to 50,000 pounds per square inch. The load F on the particulates 402 causes the particulates to bond to one another to form a competent, consolidated core or consolidated structure 600. In step 310, the consolidated structure 600 is removed from the chamber 500. The geometry of the consolidated structure 600 will depend on the geometry of the chamber 500 used. Regardless of the geometry of the chamber 500, the consolidated structure 600 may then be left as one whole piece or may be cut into smaller slices, wafers, cubes, blocks, or any desired shape 600a, 600b, 600c, . . . 600n (non-limiting examples shown in FIG. 6B) of varying thickness. In an embodiment, wafers with specific shapes and thickness may be used in conductivity testing devices.

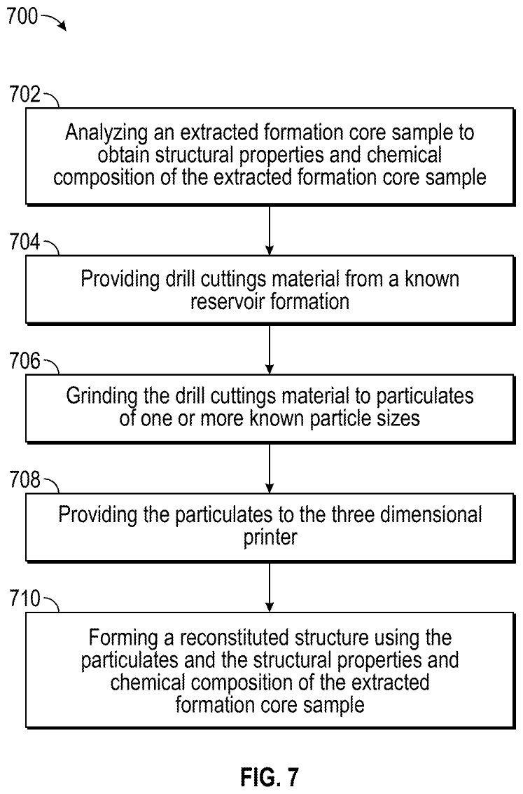

Referring now to FIG. 7, a method 700 of reconstituting formation structures with a three-dimensional printer is shown. In a first step 702, a core sample 80a is analyzed to obtain cross-sectional structural properties, mineral and chemical compositions 802 of the extracted formation core sample 80a. The cross-sectional structural properties, mineral and chemical compositions 802 of the core sample 80a are determined for each portion or “pixel” unit of the sample 80a. Any suitable analysis techniques known in the art may be used including, but not limited to, computerized tomography scan, X-ray diffraction, near-infrared spectroscopy, scanning electron microscopy, and energy-dispersive X-ray spectroscopy.

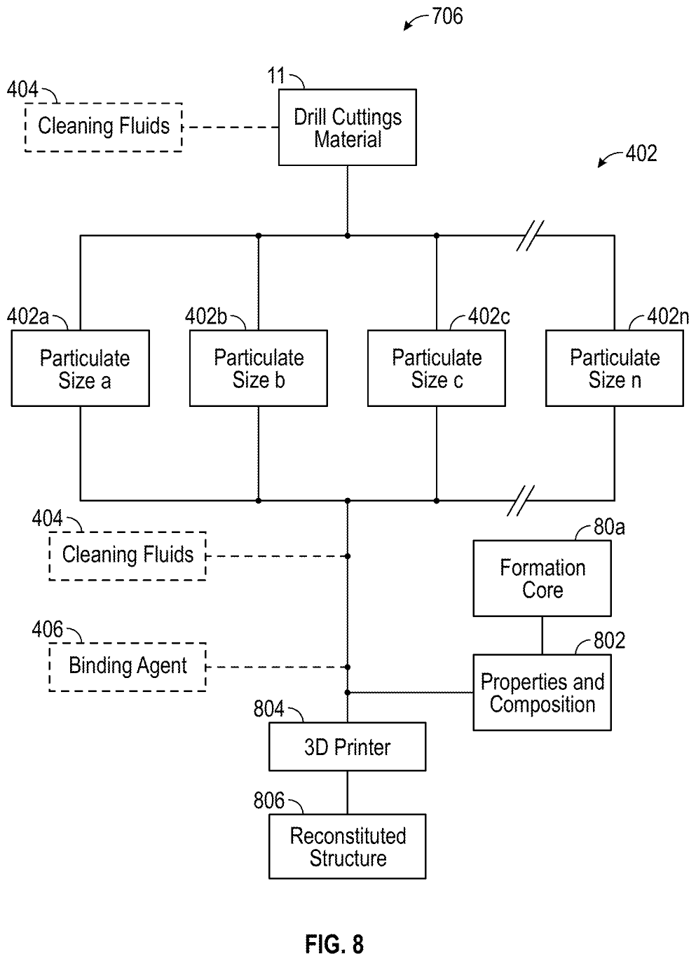

In step 704, drill cuttings 11 from a known reservoir formation 15 are provided (FIGS. 1 and 2). In step 706, the drill cuttings material 11 is ground to particulates 402 of one or more known particle sizes. Referring also to FIG. 8, step 706 is shown in further detail. Drill cuttings material 11 may be ground to a first size a forming first particulate 402a, and a portion of first particulate 402a may be further ground to a second size b forming second particulate 402b. A portion of second particulate 402b may be further ground to a third size c forming third particulate 402c, and the process may continue any number of additional times to an nth size n forming nth particulate 402n. One or more cleaning fluids 404 may optionally be applied to the drill cuttings material 11 before or after being ground to particulates 402. Any suitable cleaning fluids 404 known in the art may be used including, but not limited to, a solvent based fluid, including dipropylene glycol methyl ether, dipropylene glycol dimethyl ether, dimethyl formamide, diethyleneglycol methyl ether, ethyleneglycol butyl ether, diethyleneglycol butyl ether, propylene carbonate, butyl alcohol, d′limonene, fatty acid methyl esters, methanol, isopropanol, butanol, glycol ether solvents, diethylene glycol methyl ether, dipropylene glycol methyl ether, 2-butoxy ethanol, ethers of a C2 to C6 dihydric alkanol containing at least one C1 to C6 alkyl group, mono ethers of dihydric alkanols, methoxypropanol, butoxyethanol, hexoxyethanol, and isomers thereof, and any derivative thereof, and any combination thereof; an aqueous-based fluid comprising water and a surfactant, wherein the surfactant is an ionic surfactant, nonionic surfactant, or a combination of ionic and nonionic surfactants. The ionic surfactant is selected from the group including, but not limited to, sodium oleate, sodium stearate, sodium dodecylbenzenesulfonate, sodium myristate, sodium laurate, sodium decanoate, sodium caprylate, sodium cetyl sulfate, sodium myristyl sulfate, sodium lauryl sulfate, sodium decyl sulfate, sodium octyl sulfate, derivatives of any of the foregoing, and combinations thereof. The nonionic surfactant is selected from the group including, but not limited to, ethoxylated aliphatic alcohols, nonylphenol ethoxylates, octylphenol ethoxylates, sulfoxide esters, polyoxyethylene, carboxylic esters, polyethylene glycol esters, anhydrosorbitol ester and ethoxylated derivatives, glycol esters of fatty acids, carboxylic amides, monoalkanolamine condensates, polyoxyethylene fatty acid amides, branched alkylphenol alkoxylates, linear alkylphenol alkoxylates, branched alkyl alkoxylates, derivatives of any of the foregoing, and combinations thereof. A binding agent 406 may also be optionally added to the particulates 402. Any suitable binding agent 406 known in the art may be used including, but not limited to, an inert binding agent, a curable resin, a cement, an inorganic geopolymer, or any combination thereof.

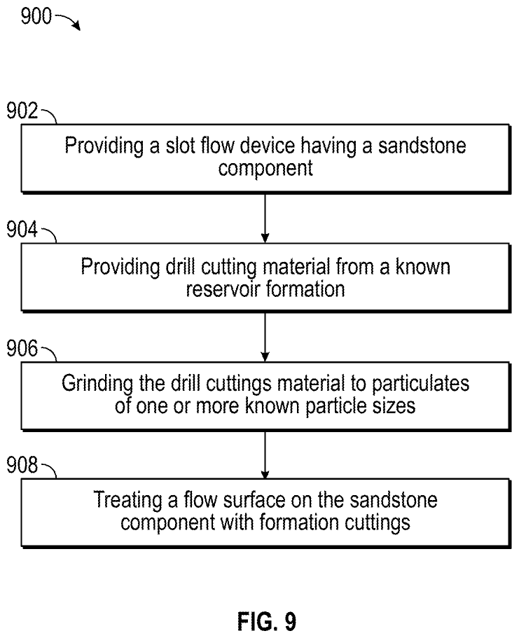

In step 708, the particulates 402 are provided to a three-dimensional printer 804. In an embodiment, particulates 402 of a generally uniform size are provided to the three-dimensional printer 804. In another embodiment, the size of the particulates 402a, 402b, 402c, . . . 4n, including the variety of sizes a, b, c, . . . n, may be selected based on the characteristics and geometry of the target reservoir formation 15. The three-dimensional printer 804 may be any suitable three-dimensional printer 804 known in the art capable of printing with particulates 402 formed from drill cutting material 11 including, but not limited to, plaster-based three-dimensional printers that use powders of particulates and inkjet-like heads. In step 710, the three-dimensional printer 804 forms a reconstituted structure 806 layer by layer using the particulates 402 and the cross-sectional structural properties, mineral and chemical compositions 802 of the extracted formation core sample 80a. The reconstituted structure 806 may be any geometry and size that the three-dimensional printer 804 is capable of producing. In an embodiment, the reconstituted structure 806 may be a reproduction of the extracted formation core sample 80a with the same geometry, porosity, density, and mineralogy. In an alternative embodiment, the reconstituted structure 806 may have a larger size than the extracted formation core sample 80a by repeating the structural properties and chemical composition 802 of the extracted formation core sample 80a. In other embodiments, the reconstituted structure 806 may by shaped differently from the extracted formation core sample 80a, but have the same structural properties and chemical composition 802. In an embodiment, the reconstituted structure 806 may have the geometry of a slot flow apparatus (see FIG. 9) described in more detail below. Regardless of the geometry of the reconstituted structure 806, the reconstituted structure 806 may then be left as one whole piece or may be cut into smaller slices, wafers, cubes, blocks, or any desired shape of varying thickness. In an additional embodiment, cross-sectional structural properties, mineral and chemical compositions 802 of the core sample 80a is saved and digitally transmitted to different locations to allow construction of one or more reconstituted structures 806 at different testing facilities. In a further embodiment, the reconstituted structure 806 may be used for testing purposes including, but not limited to acidizing, chelate etching, water imbibition, immersion, impact of surfactants on surface tension and/or osmosis, water recovery, fines migration, hydraulic fracturing, proppant embedment, and fracture face stabilization.

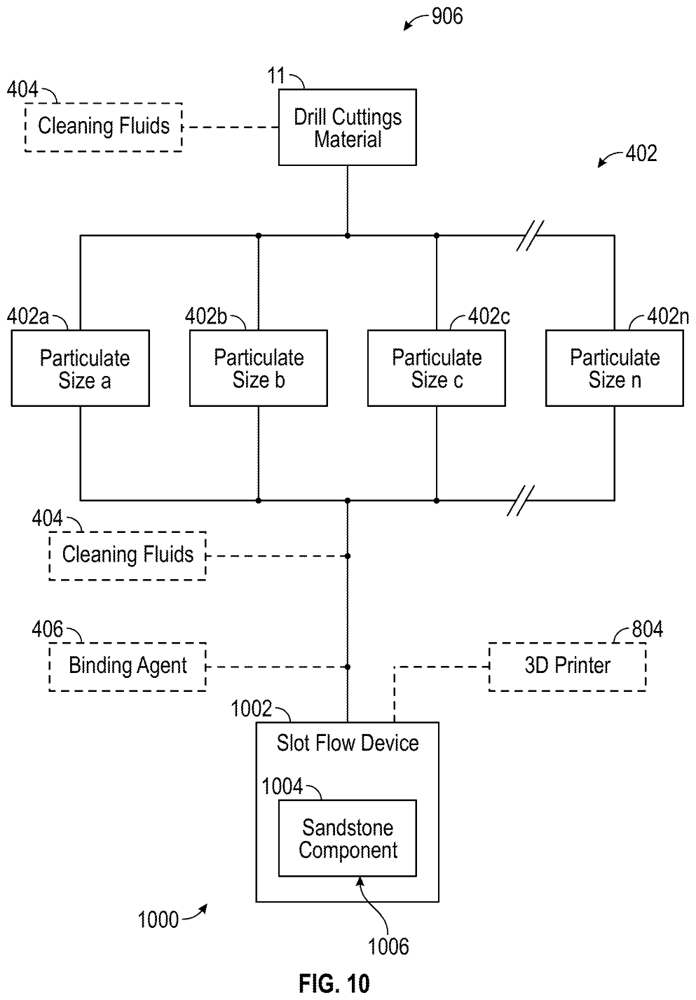

Referring now to FIG. 9 showing a method 900 of forming a slot flow apparatus and FIG. 10 showing a schematic diagram of the slot flow apparatus 1000, which comprises a slot flow device 1002. In a first step 902, the slot flow device 1002 having a sandstone component 1004 is provided. Though component 1004 is described as a sandstone component in the present embodiment, in other embodiments, component 1004 may comprise other materials known in the art including, but not limited to, polymers, resins, and other minerals.

In step 904, drill cuttings 11 from a known reservoir formation 15 are provided (FIGS. 1 and 2). In step 906, the drill cuttings material 11 is ground to particulates 402 of one or more known particle sizes. FIG. 10 illustrates step 906 in further detail. Drill cuttings material 11 may be ground to a first size a forming first particulate 402a, and a portion of first particulate 402a may be further ground to a second size b forming second particulate 402b. A portion of second particulate 402b may be further ground to a third size c forming third particulate 402c, and the process may continue any number of additional times to an nth size n forming nth particulate 402n. One or more cleaning fluids 404 may optionally be applied to the drill cuttings material 11 before or after being ground to particulates 402. Any suitable cleaning fluids 404 known in the art may be used including, but not limited to, a solvent based fluid, including dipropylene glycol methyl ether, dipropylene glycol dimethyl ether, dimethyl formamide, diethyleneglycol methyl ether, ethyleneglycol butyl ether, diethyleneglycol butyl ether, propylene carbonate, butyl alcohol, d′limonene, fatty acid methyl esters, methanol, isopropanol, butanol, glycol ether solvents, diethylene glycol methyl ether, dipropylene glycol methyl ether, 2-butoxy ethanol, ethers of a C2 to C6 dihydric alkanol containing at least one C1 to C6 alkyl group, mono ethers of dihydric alkanols, methoxypropanol, butoxyethanol, hexoxyethanol, and isomers thereof, and any derivative thereof, and any combination thereof; an aqueous-based fluid comprising water and a surfactant, wherein the surfactant is an ionic surfactant, nonionic surfactant, or a combination of ionic and nonionic surfactants. The ionic surfactant is selected from the group including, but not limited to, sodium oleate, sodium stearate, sodium dodecylbenzenesulfonate, sodium myristate, sodium laurate, sodium decanoate, sodium caprylate, sodium cetyl sulfate, sodium myristyl sulfate, sodium lauryl sulfate, sodium decyl sulfate, sodium octyl sulfate, derivatives of any of the foregoing, and combinations thereof. The nonionic surfactant is selected from the group including, but not limited to, ethoxylated aliphatic alcohols, nonylphenol ethoxylates, octylphenol ethoxylates, sulfoxide esters, polyoxyethylene, carboxylic esters, polyethylene glycol esters, anhydrosorbitol ester and ethoxylated derivatives, glycol esters of fatty acids, carboxylic amides, monoalkanolamine condensates, polyoxyethylene fatty acid amides, branched alkylphenol alkoxylates, linear alkylphenol alkoxylates, branched alkyl alkoxylates, derivatives of any of the foregoing, and combinations thereof. A binding agent 406 may also be optionally added to the particulates 402. Any suitable binding agent 406 known in the art may be used including, but not limited to, an inert binding agent, a curable resin, a cement, an inorganic geopolymer, or any combination thereof.

In step 908, a flow surface 1006 on the sandstone component 1004 is treated with the particulates 402. The particulates 402 provide grooves and curvatures on the flow surface 1006 to simulate the natural formation uneven surfaces and roughness in the wellbore 12. The simulation of the natural uneven formation surfaces provides a slot flow simulation with fracture faces having realistic geochemical properties of the wellbore 12. In an embodiment, a three-dimensional printer 804 is used to treat the flow surface 1006 with the particulates 402. The three-dimensional printer 804 may be any suitable three-dimensional printer 804 known in the art capable of printing with particulates 402 formed from drill cutting material 11. The three-dimensional printer 804 deposits the particulates 402 on the flow surface 1006.

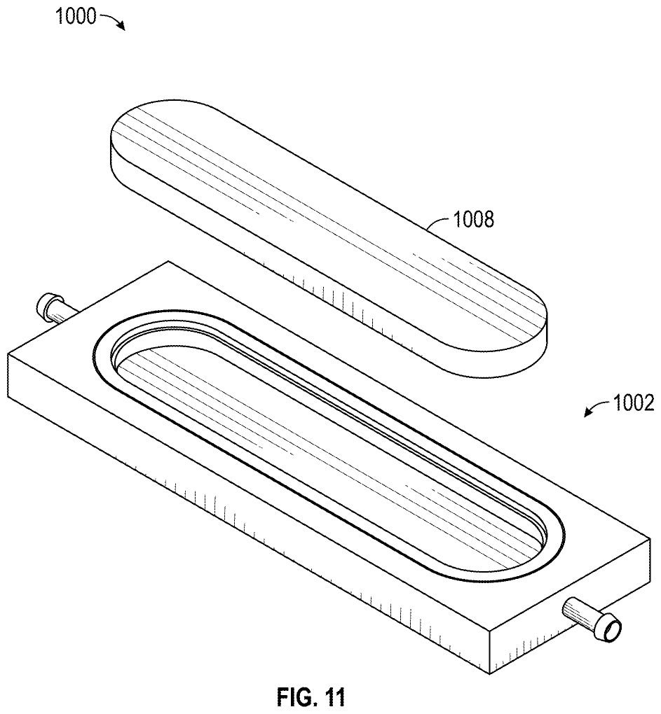

In an embodiment, the flow surface 1006 may be disposed on one side of the sandstone component 1004. In another embodiment, the sandstone component 1004 may further comprise an insert or cell 1008 where the flow surface 1006 is disposed on the insert 1008 (shown in FIG. 11). In a further embodiment, a cover glass (not shown) may be mounted on the slot flow device 1002 to monitor the flow across flow surface 1006. The slot flow apparatus 1000 can then be used for evaluating flow transport of conductor frac or propping agents and their bridging behavior in simulation treatments using realistic geochemical properties based on the mineralogy of the target reservoir formation 15.

In an embodiment, insert or cell 1008 may be prepared from other material representing the target reservoir formation 15. In an alternative embodiment, the insert or cell 1008 may be prepared using a combination of several materials such that the flow surface 1006 can be modified using various materials as coating including, but not limited to, silica, alumina, cellulose, sand, and formation cuttings.

Although various embodiments and methods have been shown and described, the disclosure is not limited to such embodiments and methods and will be understood to include all modifications and variations as would be apparent to one skilled in the art. Therefore, it should be understood that the disclosure is not intended to be limited to the particular forms disclosed; rather, the intention is to cover all modifications, equivalents, and alternatives falling within the spirit and scope of the disclosure as defined by the appended claims.

A method for reconstituting formation structures has been described. The method may generally include providing drill cuttings material from a known reservoir formation, grinding the drill cuttings material to particulates of one or more known particle sizes, packing the particulates into a chamber, applying a load to the particulates in the chamber to form a consolidated structure, and removing the consolidated structure from the chamber. Likewise, a method for reconstituting formation structures with a three dimensional printer has been described. The method may generally include analyzing an extracted formation core sample to obtain structural properties and chemical composition of the extracted formation core sample, providing drill cuttings material from a known reservoir formation, grinding the drill cuttings material to particulates of one or more known particle sizes, providing the particulates to the three dimensional printer, and forming a reconstituted structure using the particulates and the structural properties and chemical composition of the extracted formation core sample. Likewise, a method of forming a slot flow apparatus has been described. The method may generally include providing a slot flow apparatus having a sandstone component, providing drill cuttings material from a known reservoir formation, and grinding the drill cuttings material to particulates of one or more known particle sizes, treating a flow surface on the sandstone component with the particulates. For the foregoing embodiments, the method may include any one of the following steps, alone or in combination with each other:

Applying one or more cleaning fluids to the drill cuttings forming cleaned drill cuttings.

Coating the cleaned drill cuttings with a binding agent.

Applying a load to the drill cuttings comprises gradually increasing the load and maintaining a high stress load for a period of time.

The binding agent is a curable resin, a cement, an inorganic geopolymer, or any combination of a curable resin, a cement, and an inorganic geopolymer.

The drill cuttings material comprises remnants of drilled formation cores.

The chamber is generally cylindrical-shaped and the reconstituted structure is a consolidated core.

The chamber is generally block-shaped and the reconstituted structure is a slot flow apparatus.

Coating the cleaned drill cuttings with an inert binding agent.

Analyzing the extracted formation core sample is performed with at least one of X-ray diffraction, near-infrared spectroscopy, scanning electron microscopy, and energy-dispersive X-ray spectroscopy.

The reconstituted structure is a consolidated formation core.

The reconstituted structure is a consolidated slot flow apparatus.

The reconstituted structure is an insert having a flow surface that is removably disposed in a recess of a slot flow apparatus.

Treating a flow surface on the sandstone component with particulates comprises providing the particulates to a three dimensional printer to coat the flow surface with grooves and curvatures formed by the particulates.

The sandstone component comprises at least one side of the slot flow apparatus.

The sandstone component comprises an insert that is removably disposed in a recess on the slot flow device.

The cleaning fluid is a solvent based fluid, including dipropylene glycol methyl ether, dipropylene glycol dimethyl ether, dimethyl formamide, diethyleneglycol methyl ether, ethyleneglycol butyl ether, diethyleneglycol butyl ether, propylene carbonate, butyl alcohol, d′limonene, fatty acid methyl esters, methanol, isopropanol, butanol, glycol ether solvents, diethylene glycol methyl ether, dipropylene glycol methyl ether, 2-butoxy ethanol, ethers of a C2 to C6 dihydric alkanol containing at least one C1 to C6 alkyl group, mono ethers of dihydric alkanols, methoxypropanol, butoxyethanol, hexoxyethanol, and isomers thereof, and any derivative thereof, and any combination thereof.

The cleaning fluid is an aqueous-based fluid comprising water and a surfactant, wherein the surfactant is an ionic surfactant, nonionic surfactant, or a combination of ionic and nonionic surfactants.

The ionic surfactant is selected from the group including, but not limited to, sodium oleate, sodium stearate, sodium dodecylbenzenesulfonate, sodium myristate, sodium laurate, sodium decanoate, sodium caprylate, sodium cetyl sulfate, sodium myristyl sulfate, sodium lauryl sulfate, sodium decyl sulfate, sodium octyl sulfate, derivatives of any of the foregoing, and combinations thereof.

The nonionic surfactant is selected from the group including, but not limited to, ethoxylated aliphatic alcohols, nonylphenol ethoxylates, octylphenol ethoxylates, sulfoxide esters, polyoxyethylene, carboxylic esters, polyethylene glycol esters, anhydrosorbitol ester and ethoxylated derivatives, glycol esters of fatty acids, carboxylic amides, monoalkanolamine condensates, polyoxyethylene fatty acid amides, branched alkylphenol alkoxylates, linear alkylphenol alkoxylates, branched alkyl alkoxylates, derivatives of any of the foregoing, and combinations thereof.

Providing the particulates to the three dimensional printer comprises providing particulates of a generally uniform size.

The three-dimensional printer is a plaster-based three dimensional printer that uses powders of particulates and inkjet-like heads.

The reconstituted structure is a reproduction of the extracted formation core sample with the same geometry, porosity, density, and mineralogy.

The reconstituted structure has a larger size than the extracted formation core sample by repeating the structural properties and chemical composition of the extracted formation core sample.

The reconstituted structure is shaped differently from the extracted formation core sample while having the same structural properties and chemical composition of the extracted formation core sample.

Cutting the reconstituted structure into smaller slices, wafers, cubes, blocks, or any desired shape of varying thickness.

Saving and digitally transmitting cross-sectional structural properties, mineral and chemical compositions of the extracted formation core sample to different locations, constructing one or more reconstituted structures at different testing facilities.

Testing the reconstituted structure for acidizing, chelate etching, water imbibition, immersion, impact of surfactants on surface tension and/or osmosis, water recovery, fines migration, hydraulic fracturing, proppant embedment, and fracture face stabilization.

The sandstone component is made of a polymer, resin, or other minerals.

Treating the flow surface on the sandstone component with the particulates using a three-dimensional printer.

Preparing the insert using any combination of silica, alumina, cellulose, sand, and formation cuttings.

1. A method of reconstituting formation structures, the method comprising:
providing drill cuttings material from a known reservoir formation;
grinding the drill cuttings material to particulates of one or more known particle sizes;
packing the particulates into a chamber;
applying a load to the particulates in the chamber to form a consolidated structure; and
removing the consolidated structure from the chamber.

2. The method of claim 1, further comprising applying one or more cleaning fluids to the drill cuttings forming cleaned drill cuttings.

3. The method of claim 2, further comprising coating the cleaned drill cuttings with a binding agent.

4. The method of claim 1, wherein applying a load to the drill cuttings comprises gradually increasing the load and maintaining a high stress load for a period of time.

5. The method of claim 3, wherein the binding agent is a curable resin, a cement, an inorganic geopolymer, or any combination of a curable resin, a cement, and an inorganic geopolymer.

6. The method of claim 1, wherein the drill cuttings material comprises remnants of drilled formation cores.

7. The method of claim 1, wherein the chamber is generally cylindrical-shaped and the reconstituted structure is a consolidated core.

8. The method of claim 1, wherein the chamber is generally block-shaped and the reconstituted structure is a slot flow apparatus.

9. A method of reconstituting formation structures with a three dimensional printer, the method comprising:
analyzing an extracted formation core sample to obtain structural properties and chemical composition of the extracted formation core sample;
providing drill cuttings material from a known reservoir formation;
grinding the drill cuttings material to particulates of one or more known particle sizes;
providing the particulates to the three dimensional printer; and
forming a reconstituted structure using the particulates and the structural properties and chemical composition of the extracted formation core sample.

10. The method of claim 9, further comprising applying one or more cleaning fluids to the drill cuttings forming cleaned drill cuttings.

11. The method of claim 10, further comprising coating the cleaned drill cuttings with an inert binding agent.

12. The method of claim 9, wherein the drill cuttings material comprises remnants of drilled formation cores.

13. The method of claim 9, wherein analyzing the extracted formation core sample is performed with at least one of X-ray diffraction, near-infrared spectroscopy, scanning electron microscopy, and energy-dispersive X-ray spectroscopy.

14. The method of claim 9, wherein the reconstituted structure is a consolidated formation core.

15. The method of claim 9, wherein the reconstituted structure is a consolidated slot flow apparatus.

16. The method of claim 9, wherein the reconstituted structure is an insert having a flow surface that is removably disposed in a recess of a slot flow apparatus.

17. A method of forming a slot flow apparatus, the method comprising:
providing a slot flow apparatus having a sandstone component;
providing drill cuttings material from a known reservoir formation; and
grinding the drill cuttings material to particulates of one or more known particle sizes;
treating a flow surface on the sandstone component with the particulates.

18. The method of claim 17, wherein treating a flow surface on the sandstone component with particulates comprises providing the particulates to a three dimensional printer to coat the flow surface with grooves and curvatures formed by the particulates.

19. The method of claim 18, wherein the sandstone component comprises at least one side of the slot flow apparatus.

20. The method of claim 18, wherein the sandstone component comprises an insert that is removably disposed in a recess on the slot flow device.
